(19) United States
(12) Patent Application Publication
(10) Pub. No.: US 2021/0310718 A1
(43) Pub. Date: Oct. 7, 2021

(54) Portable Misting Fan

(71) Applicant: O2COOL, LLC, Chicago, IL (US)

(72) Inventors: Tom Zeng, Shenzhen (CN); Jeff Bull, Naperville, IL (US)

(21) Appl. No.: 16/839,595

(22) Filed: Apr. 3, 2020

(51) Int. Cl. F25D 7/00; B05B 7/00

(52) U.S. Cl. CPC F25D 7/00; B05B 7/0081

(57) ABSTRACT

A necklace misting fan includes a housing, a water reservoir, spray pump system, power supply, fan, and motor within the housing, an air inlet on a front side of the housing, and an air outlet on a top side of the housing. A fan power switch and a spray pump actuator are mounted to the housing. A spray nozzle on the top side of the housing horizontally spaced from the air outlet, is adapted and configured to emit a water spray generally vertically upward and obliquely to a generally vertical upward discharge air stream from the air outlet, when the spray pump actuator is actuated.

### FIELD OF THE DISCLOSURE

This present disclosure pertains to portable misting fans. More particularly, the present disclosure pertains to portable handheld or wearable misting fans.

### BACKGROUND

Portable electric fans provide a popular means of keeping cool outdoors and in other non-climate controlled environments. Some are handheld, some connect to a necklace or lanyard to be worn about the neck, and some incorporate a water reservoir and spray mister to complement the air stream provided by the fan. Mist in the air stream can cool the air stream through evaporation before the air stream reaches a user's skin, as well as some of the mist reaching the user's skin in liquid phase and cooling the user's skin directly by evaporating therefrom. Still, there is a desire for a compact necklace misting fan having a flat profile against a user's chest or abdomen when worn, which provides a convenient way to actuate a misting spray when worn as well as resisting unintended actuation.

### SUMMARY

An aspect of the present disclosure is a misting fan. A housing of the misting fan has a top wall at a top side of the housing, a bottom wall at a bottom side of the housing, a first sidewall at a first lateral side of the housing, a second sidewall at a second lateral side of the housing, a front wall at a front side of the housing, and a rear wall at a rear side of the housing. The top side is spaced in a vertical upward direction from the bottom side, and the bottom side is spaced in a vertical downward direction from the top side, the downward direction being opposite to the upward direction. The first lateral side is spaced from the second lateral side in a first horizontal direction, and the second lateral side is spaced from the first lateral side in a second horizontal direction, the second horizontal direction being opposite to the first horizontal direction. A fan compartment is disposed within the housing. A centrifugal fan is housed within the fan compartment, the centrifugal fan being adapted and configured to rotate about a fan axis. The fan axis defines a horizontal axial forward direction, a horizontal axial rearward direction, and radial directions perpendicular to the axis. Thus, the housing front side is spaced in the forward direction from the housing rear side, and the housing rear side is spaced in the rearward direction from the housing front side. An air inlet at the front side of the housing is in fluid communication with the exterior of the housing and with the fan compartment. An air outlet at the top side of the housing is in fluid communication with the exterior of the housing and with the fan compartment. The centrifugal fan is adapted and configured such that, when the centrifugal fan is rotated about the fan axis, air is drawn into the fan compartment from the exterior of the housing in an intake air stream through the air inlet, and air is discharged generally upward from within the fan compartment to the exterior of the housing in a discharge air stream through the air outlet. A water reservoir is housed within the housing. The water reservoir has a fill opening and a water reservoir closure member. The closure member is adapted and configured to removably engage the fill opening to cover and seal the fill opening. A spray nozzle is disposed at the top side of the housing, spaced horizontally from the air outlet. A spray pump within the housing is adapted and configured to be in fluid communication with water in the water reservoir and with the spray nozzle. The spray pump is adapted and configured, when actuated and in fluid communication with water in the water reservoir, to draw water from the water reservoir to the spray pump, and to impel water from the spray pump to the spray nozzle and through the spray nozzle to the exterior of the housing. The spray nozzle is adapted and configured such that, when water is impelled through the spray nozzle to the exterior of the housing, a water spray is discharged from the spray nozzle to the exterior of the housing, at least a portion of the water spray being discharged in a generally upward direction. A spray pump actuator is movably mounted to the housing, being adapted and configured to actuate the spray pump when an actuation force is applied to the spray pump actuator to move the spray pump actuator from a home position relative to the housing to an actuation position relative to the housing.

Further features and advantages, as well as the operation, are described in detail below with reference to the accompanying drawings.

### BRIEF DESCRIPTION OF THE DRAWINGS

FIG. 1 is a top-right front perspective view of a necklace misting fan according to an embodiment.

FIG. 2 is a left side elevation view of the fan of FIG. 1.

FIG. 3 is right side elevation view of the fan of FIG. 1.

FIG. 4A is a front side elevation view of the fan of FIG. 1.

FIG. 4B is a front side elevation view of the fan of FIG. 1 with an actuator depressed.

FIG. 5 is a rear side elevation view of the fan of FIG. 1.

FIG. 6 is a top plan view of the fan of FIG. 1.

FIG. 7 is a bottom plan view of the fan of FIG. 1.

FIG. 8 is a top-left front perspective view of the fan of FIG. 1.

FIG. 9 is a rear perspective exploded view of the fan of FIG. 1, with a battery compartment cover omitted.

FIG. 10 is a front-left perspective view of a rear wall of the fan of FIG. 1.

FIG. 11 is a top-right rear perspective view of the fan of FIG. 1 with a rear wall omitted.

FIG. 12 is a top-left rear perspective view of a front wall of the fan of FIG. 1.

FIG. 13 is a front elevation view of the fan of FIG. 1 with a front wall omitted.

FIG. 14 is a clockwise-rotated front view of a water spray pump assembly of the fan of FIG. 1.

FIG. 15 is an exploded bottom-left front perspective view of a water reservoir of the fan of FIG. 1.

FIG. 16 is a cross-sectional front elevation view of the fan of FIG. 1.

Reference numerals in the written specification and in the figures indicate corresponding items.

### DETAILED DESCRIPTION

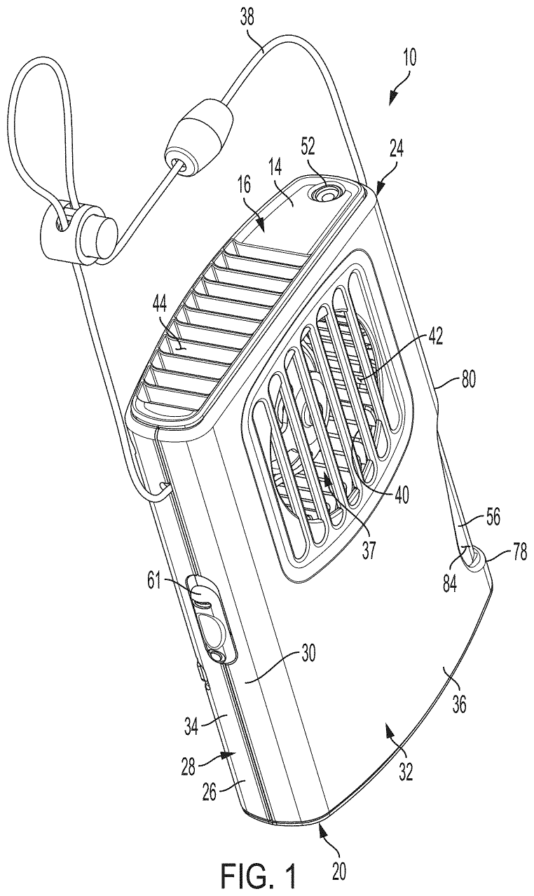

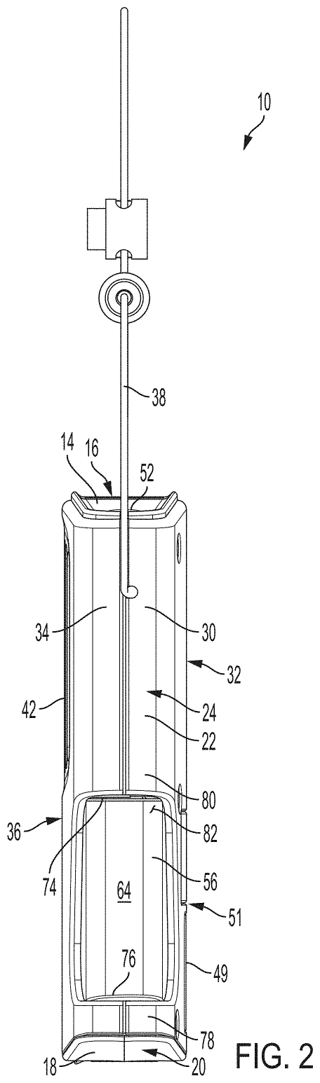

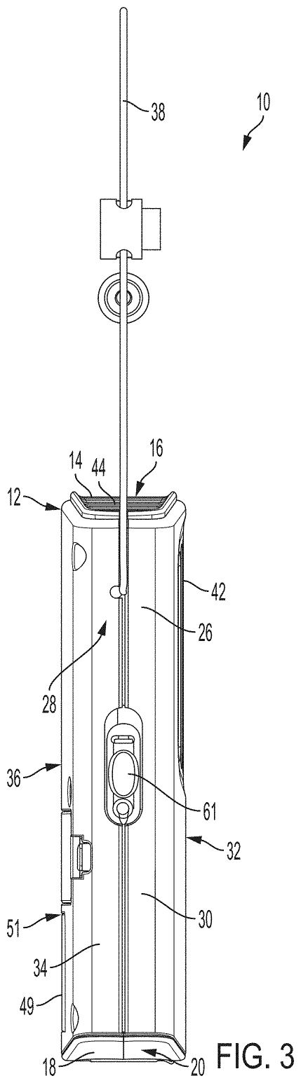

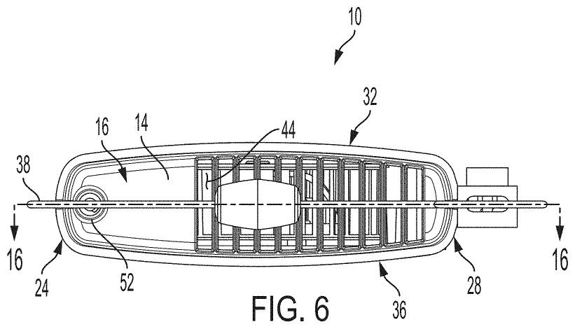

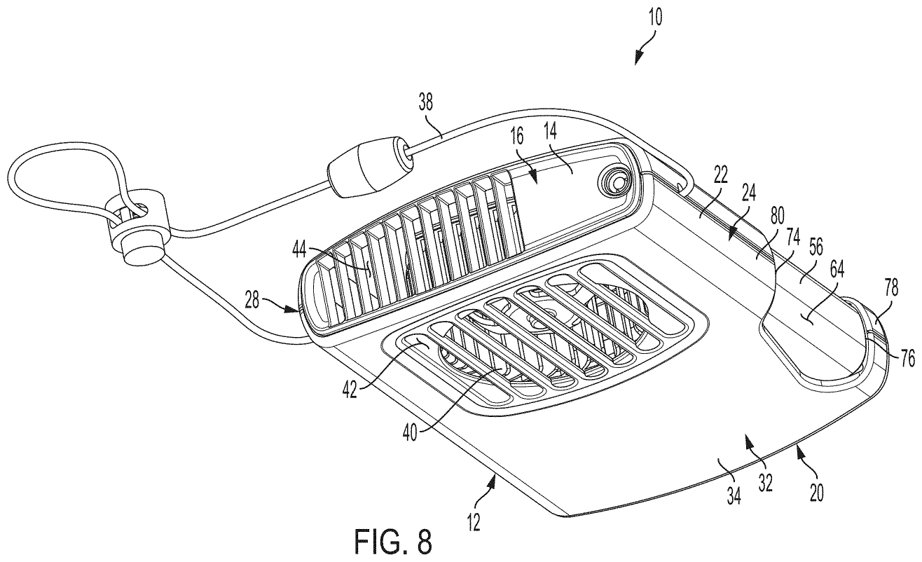

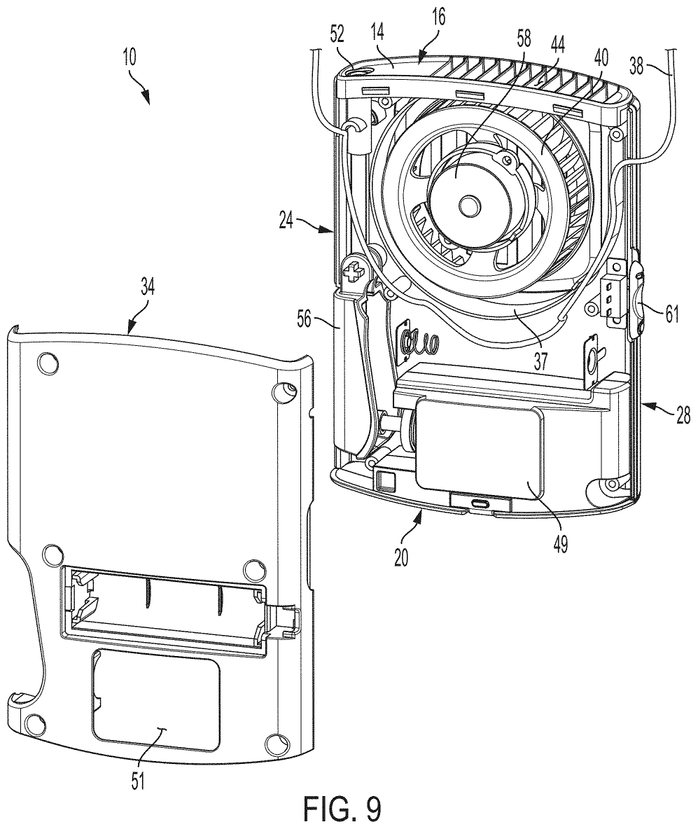

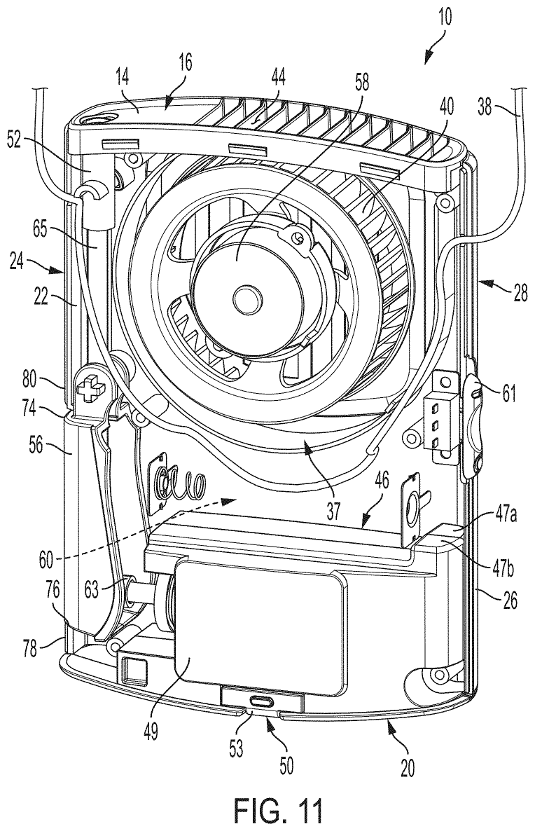

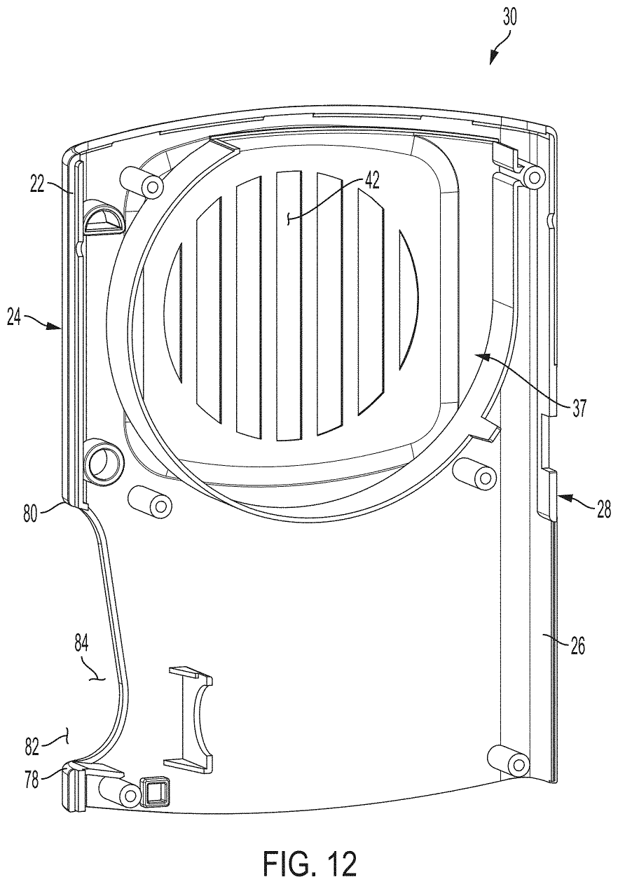

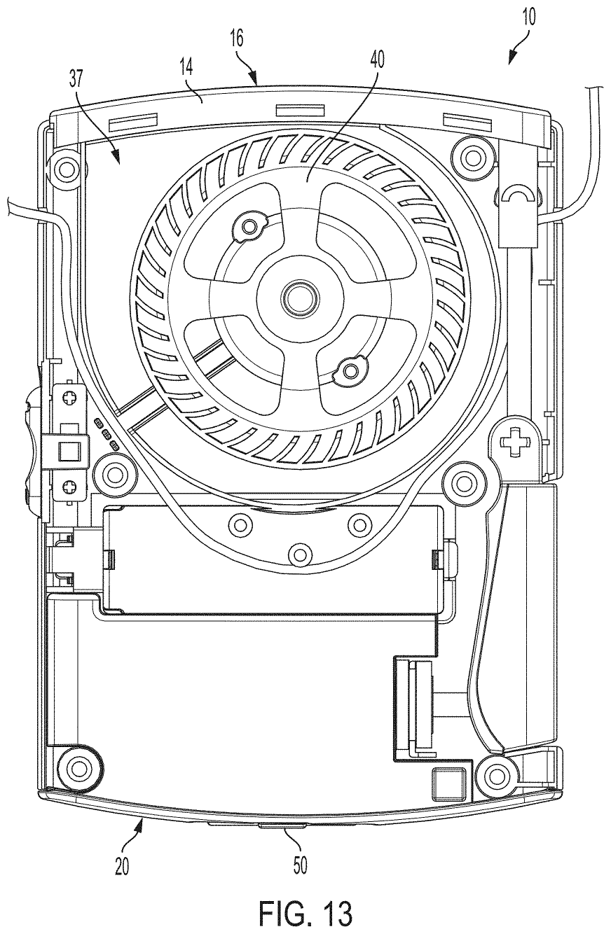

An embodiment of a misting fan 10 in accordance with the present disclosure is illustrated in FIGS. 1-16. The misting fan 10 comprises a housing 12 having a top wall 14 at a top side 16 of the housing 12, a bottom wall 18 at a bottom side 20 of the housing 12, a first sidewall 22 at a first lateral side 24 of the housing 12, a second sidewall 26 at a second lateral side 28 of the housing 12, a front wall 30 at a front side 32 of the housing 12, and a rear wall 34 at a rear side 36 of the housing 12. In the illustrated embodiment, the front wall 30 and the rear wall 34 are joined in a clamshell assembly in which respective lateral flange portions of each the front wall 30 and the rear wall 34 come together to form the first sidewall 22 and the second sidewall 26. Directions for reference in describing the misting fan 10 may be defined with respect to the housing 12, as follows. The top side 16 is spaced in a vertical upward direction from the bottom side 20, the bottom side 20 being spaced in a vertical downward direction from the top side 16, the downward direction being opposite to the upward direction. The first lateral side 24 is spaced from the second lateral side 28 in a first horizontal direction, and the second lateral side 28 is spaced from the first lateral side 24 in a second horizontal direction, the second horizontal direction being opposite to the first horizontal direction. The misting fan 10 includes a fan compartment 37 within the housing 12 and a centrifugal fan 40 within the fan compartment 37. The centrifugal fan 40 is adapted and configured to rotate about a fan axis, the fan axis defining a horizontal axial forward direction parallel to the axis, a horizontal axial rearward direction opposite the forward direction, and radial directions perpendicular to the axis. The housing front side 32 is spaced in the forward direction from the housing rear side 36, and the housing rear side 36 is spaced in the rearward direction from the housing front side 32.

An air inlet 42 is included at the front side 32 of the housing 12, the air inlet 42 being in fluid communication with the exterior of the housing 12 and with the fan compartment 37. An air outlet 44 at the top side 16 of the housing 12, the air outlet 44 being in fluid communication with the exterior of the housing 12 and with the fan compartment 37. The centrifugal fan 40 is adapted and configured such that, when the centrifugal fan 40 is rotated about the fan axis, air is drawn into the fan compartment 37 from the exterior of the housing 12 in an intake air stream through the air inlet 42 and air is discharged generally upward from within the fan compartment 37 to the exterior of the housing 12 in a discharge air stream through the air outlet 44.

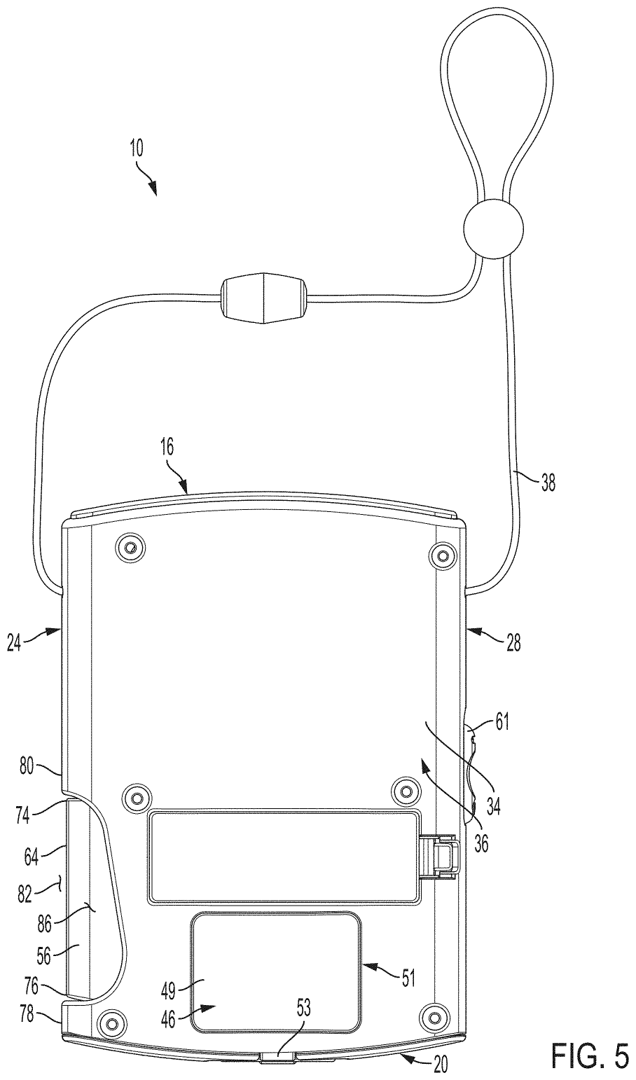

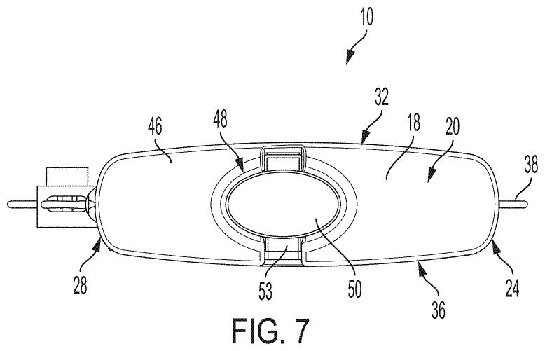

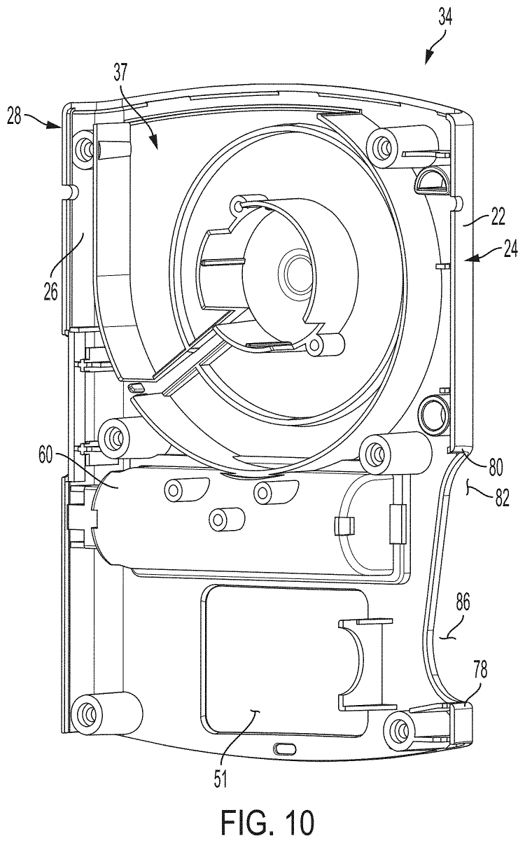

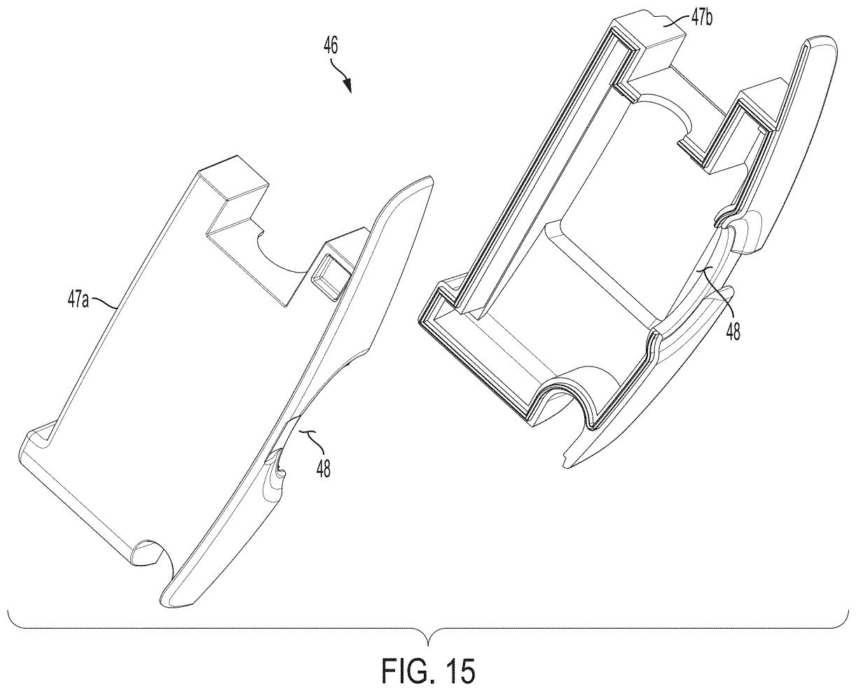

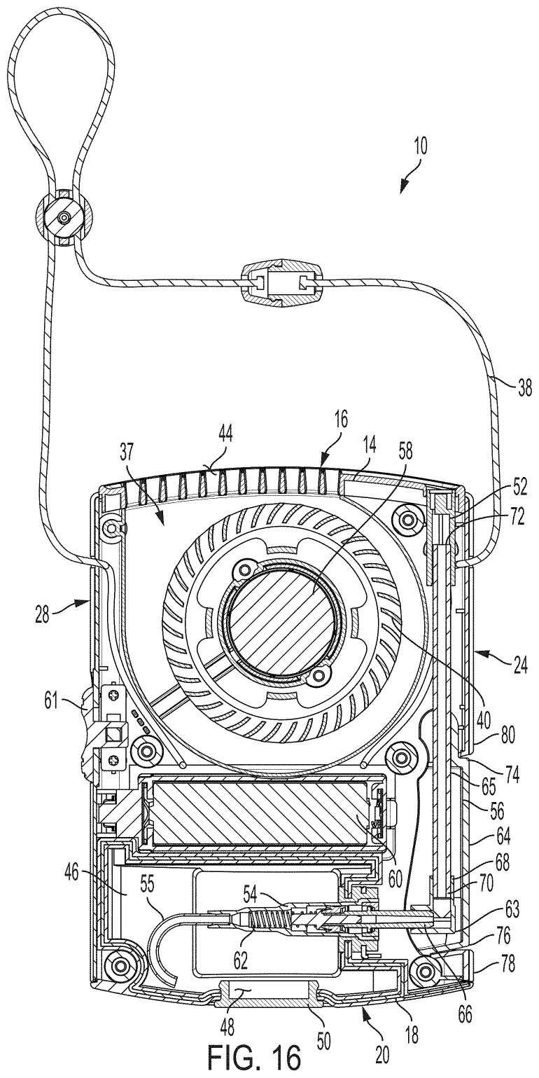

A water reservoir 46 is included within the housing 12, the water reservoir 46 having a fill opening 48 (see FIGS. 15, 16) and a water reservoir closure member 50 adapted and configured to removably engage the fill opening 48 to cover and seal the fill opening 48. The water reservoir 46 may be of a two-piece clamshell construction, as illustrated in FIG. 15, comprising a forward member 47a and a rearward member 47b, the rearward member 47b comprising a window 49 adapted and configured to align with an opening 51 (FIG. 10) in the housing rear wall 34, as shown, e.g., in FIG. 5, for convenient viewing of a water level within the water reservoir 46. Preferably, the fill opening 48 is disposed on the bottom side 20 of the housing 12, the bottom side 20 having a compact area providing convenient access to the fill opening 48. The closure member 50 is preferably attached to the housing 12, such as by a band 53 (FIGS. 5, 7) of flexible material that operates as a living hinge. The band 53 may attach to the housing 12 rearward of the fill opening 48, as shown in FIGS. 5 and 7, or forward of the fill opening 48 (not shown), to allow the closure member 50 to pivot away from a stream of water when the housing 12 is tilted forward or rearward toward the stream of water for filling. Alternatively, the band 53 may attach to the housing at another suitable location.

A spray nozzle 52 is provided at the top side 16 of the housing 12, the spray nozzle 52 being spaced horizontally from the air outlet 44. A spray pump 54 is included within the housing 12, the spray pump 54 being adapted and configured to be in fluid communication with water in the water reservoir 46 and with the spray nozzle 52, the spray pump 54 being adapted and configured, when actuated and in fluid communication with water in the water reservoir 46, to draw water from the water reservoir 46 through a dip tube 55 to the spray pump 54, and to impel water from the spray pump 54 to the spray nozzle 52 and through the spray nozzle 52 to the exterior of the housing 12. The spray nozzle 52 is adapted and configured such that, when water is impelled through the spray nozzle 52 to the exterior of the housing 12, a water spray is discharged generally upward from the spray nozzle 52 to the exterior of the housing. For example, the water spray, or a portion of the water spray, may be discharged in a direction inclined at least forty-five degrees, more preferably at least sixty degrees, or still more preferably at least seventy-five degrees from a horizontal plane. Preferably, at least a portion of the water spray is discharged in an oblique direction having an upward direction component and a slight horizontal direction component towards the air outlet 44, without diverting too much of the spray from being directed toward a wearer's face. That is, a portion of the water spray is discharged obliquely to the discharge air stream, so as to be directed into the discharge air stream, preferably in the form of a mist, so that evaporation of mist particles in the discharge air stream serves to cool the discharge air stream, and any liquid droplets carried by the air stream onto a user's skin serve to cool the user's skin directly by evaporating therefrom. Without limitation, the term “mist” here refers to a large number of tiny water droplets in air, the droplets being small enough that they tend either to evaporate or to float in the air, rather than being accelerated towards the earth by gravity. A spray may be (or include) a “mist” even if the spray also includes water droplets large enough to fall through the air.

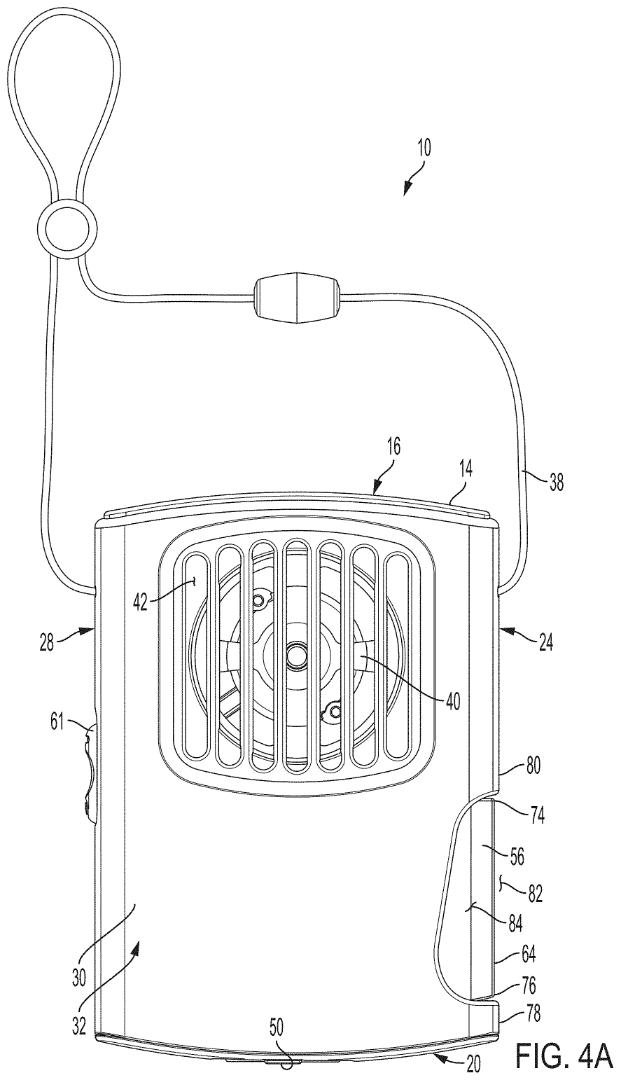

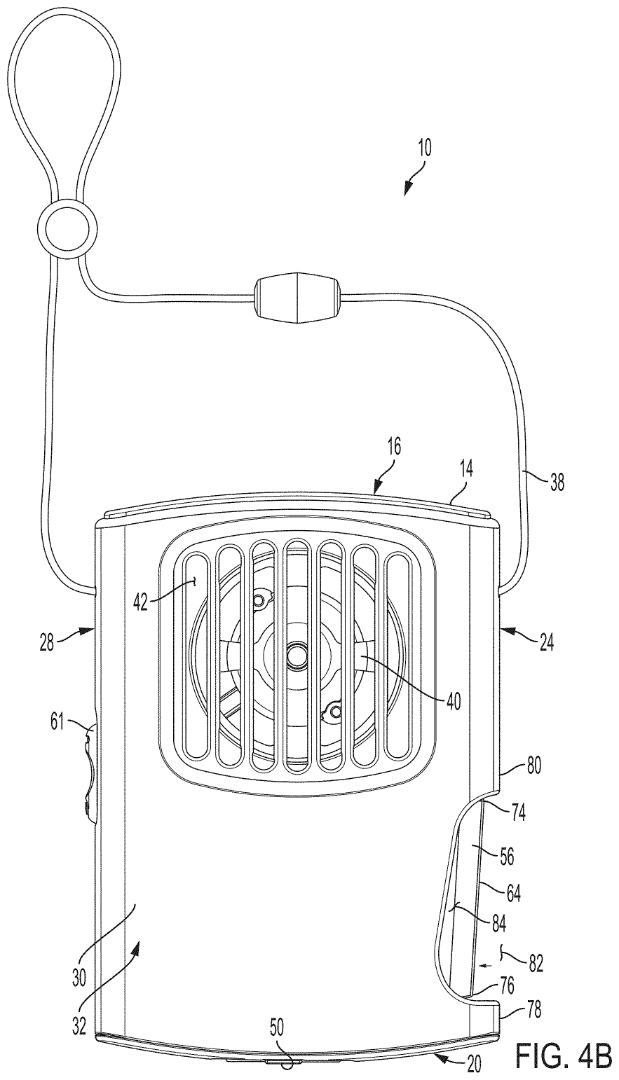

The misting fan 10 further includes a spray pump actuator 56, movably mounted to the housing 12. The spray pump actuator 56 is adapted and configured to actuate the spray pump 54 when an actuation force is applied to the spray pump actuator 56 to move the spray pump actuator 56 from a home position relative to the housing 12, shown in FIG. 4A, to an actuation position relative to the housing 12, as illustrated in FIG. 4B.

The misting fan 10 includes a motor 58 within the housing 12, the motor 58 being adapted and configured to drive rotation of the centrifugal fan 40 about the fan axis. An electrical power supply 60, which may be a standard AA battery as illustrated in cross section in FIG. 16, or alternatively a rechargeable or secondary cell battery, preferably equipped with a charging port mounted in the housing 12, is operatively connected to the motor 58 to provide power to energize the motor 58. A power switch 61, illustrated as being mounted on the second sidewall 26, is adapted and configured to switch power to the motor 58 on and off. The electrical power supply 60 is located within the housing 12 below the fan compartment 37 and above the water reservoir 46. This intermediate position of the electrical power supply 60 conveniently leaves an upper portion of the housing 12 available for the fan compartment 37 to be located in communication with the air outlet 44 on the top side 16 of the housing 12, while at the same time leaving a lower portion of the housing 12 available for the water reservoir 46, to be located conveniently adjacent the bottom side 20 of the housing 12. Thus, in the illustrated embodiment, a discharge grille plate comprising the air outlet 44 constitutes the top wall 14 of the housing, and a bottom wall of the water reservoir 46 constitutes the bottom wall 18 of the housing.

Preferably, the misting fan 10 includes a necklace or lanyard 38 that is connected to the housing 12, either permanently or removably, in such a manner that when the necklace is worn about the neck of a user, the housing 12 settles to an upright configuration, i.e., the downward direction defined by the housing aligns with the direction of gravity. Thus, the air outlet 44 and the spray nozzle 52 are aligned to direct the discharge a cooling combination of the air stream and water spray toward a user's neck, chin, and/or face. In the illustrated embodiment, the first lateral side 24 is a left side of the housing 12 and the second lateral side 28 is a right side of the housing 12. This conveniently allows a user wearing the misting fan 10 by the necklace 38 to reach a right hand across the front of the housing 12 and grip the housing 12 by the second sidewall 26 and the spray pump actuator 56 to depress the spray pump actuator 56 using two or more fingers of the right hand, typically including at least two adjacent fingers of the index, middle, ring, and little fingers, with the thumb or heel of the right hand braced against the second sidewall 26. An alternative embodiment of a misting fan (not shown), having elements in a mirror image arrangement with respect to those of misting fan 10, allows similar actuation by a user's left hand.

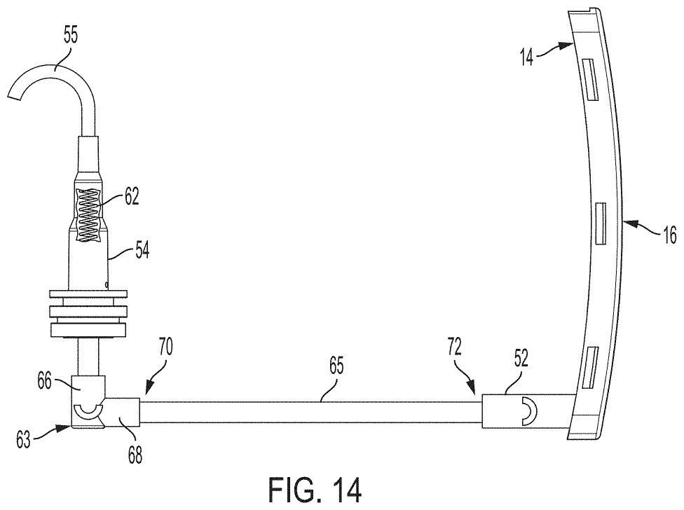

The misting fan 10 further includes a biasing member 62 operatively connected between the housing 12 and the actuator 56, the biasing member 62 being adapted and configured to bias the actuator 56 toward the home position. As seen in FIG. 14, the biasing member 62 is a helical spring incorporated in the spray pump 54. Preferably, a biasing member is adapted and configured to permit actuation of a spray pump only when an actuation force is greater than 0.5 lbf, more preferably to permit actuation only when an actuation force is greater than 1 lbf, and still more preferably to permit actuation only when an actuation force is greater than 1.5 lbf, the actuation force being applied in a general direction of least resistance and at a general location on an actuator of least resistance. For example, for a pivotally mounted actuator like the spray pump actuator 56, the biasing member 62 preferably operates to require an actuation force of at least 1.0 lbf, and more preferably at least 1.5 lbf, applied generally perpendicularly to the pivotal axis at or near the farthest point on the actuation surface from the pivotal axis.

Connectivity and components of a pump/spray system are best illustrated in FIG. 14. The misting fan 10 further includes a spray pump connector 63 and a connector tube 65, the spray pump connector 63 having an inlet section 66 and an outlet section 68, the connector tube 65 having a first end 70 and a second end 72, the spray pump connector inlet section 66 facing horizontally and being connected to the spray pump 54, the spray pump connector outlet section 68 facing upward and being connected to the first end 70 of the connector tube 65, the second end 72 of the connector tube 65 being connected to the spray nozzle 52. The spray pump actuator 56 is adapted and configured to move the spray pump connector 63 in a horizontal direction when the actuation force is applied, the spray pump 54 being adapted and configured to be actuated when the spray pump connector 63 is moved in the horizontal direction, and the connector tube 65 being adapted and configured to flex, and to remain connected to the spray pump connector 63 and to the spray nozzle 52, when the spray pump connector 63 is moved in the horizontal direction. Preferably, the connector tube 65 is to the lateral side of the fan compartment 37 that is closer to the fan axis, opposite the lateral side of the fan compartment 37 that extends to the air outlet 44. This allows the fan 40 to be laterally centered in the housing 12, while limiting the interior width required for the housing 12 to accommodate the fan compartment 37 and the connector tube 65 side-by-side. Thus, as illustrated, the connector tube 65 is disposed between the fan compartment 37 and the first lateral side 24 of the housing 12. Alternatively, the orientation of the fan compartment 37 could be reversed, with the connector tube 65 disposed between the fan compartment 37 and the second lateral side 28 of the housing 12, such as in the previously described mirror image arrangement of the components of the misting fan 10, providing for left-handed spray-pump actuation analogous to the right-handed spray-pump actuation of the misting fan 10.

The actuator 56 has an actuation surface 64 The actuation surface 64 in the home position has an upward end 74 and a downward end 76, the actuation surface 64 in the home position facing generally in the first horizontal direction. The first sidewall 22 has a lower first sidewall portion 78 extending downward below the actuation surface downward end 76 in the home position, the first sidewall 22 having an upper first sidewall portion 80 extending upward above the actuation surface upward end 74 in the home position. An actuation surface of a necklace misting fan spray pump actuator according to the present disclosure is preferably “wide” enough to accommodate at least two typical adult fingers side-by-side, so that two or more fingers may comfortably cooperate to apply an actuation force. For example, in the illustrated embodiment, the actuation surface 64 may have a height of at least 1.0 inch, or more preferably at least 1.5 inches, measured vertically from the upward end 74 to the downward end 76. Preferably, a ratio of a height of the housing 12, that is, a greatest vertical distance from the housing bottom side 20 to the housing top side 16, to the height of the actuation surface 64, is not greater than 4.0, and more preferably not greater than 3.0.

The spray pump actuator is mounted in a slot in the housing 12, the slot defined by open areas on the housing first lateral side 24, the housing front side 32, and the housing rear side 36. In particular, the housing first lateral side 24 has a housing first lateral side open area 82 extending vertically from the upper first sidewall portion 80 to the lower first sidewall portion 78 and horizontally from the housing front side 32 to the housing rear side 36. The actuation surface 64 in the home position extends over substantially an entire height of the housing first lateral side open area, vertically from the lower first sidewall portion 78 to the upper first sidewall portion 80. The housing first lateral side open area 82 has a substantial height, so as to accommodate that of the actuation surface 64. Preferably, the housing first lateral side open area 82 has a height not less than about 1.0 inch, more preferably not less than about 1.5 inches, and still more preferably not less than about 1.75 inches. The housing front side 32 has a housing front side open area 84, and the housing rear side 36 has a housing rear side open area 86, each of the housing front side and housing rear side open areas 84, 86 being adjacent to and extending in the second horizontal direction from the housing first lateral side open area 82. Preferably, each of the housing front side and housing rear side open areas 84, 86 extends vertically alongside the housing first lateral side open area 82 from the lower first sidewall portion 78 to the upper first sidewall portion 80.

Preferably, a portable misting fan spray pump actuator in the home position does not protrude or protrudes only minimally from a portable misting fan housing. More preferably, as in the illustrated embodiment, the spray pump actuator 56 does not extend forward beyond the housing front side open area 84, does not extend rearward beyond the housing rear side open area 86, and does not extend in the first horizontal direction beyond the housing first lateral side open area 82. Still more preferably, and also as In the illustrated embodiment, the spray pump actuator 56 is recessed rearwardly from the housing front side open area 84, recessed in the second horizontal direction from the housing first lateral side open area 82, and recessed forwardly from the housing rear side open area 86.

Several attributes of the actuator 56 work beneficially in combination with one another. The spray pump actuator 56 not protruding from the housing 12 essentially prevents accidental spray pump actuation by a force of practically any (non-destructive) magnitude from a broad, flat surface, such as an interior surface of a purse, handbag, or backpack, or from a broad flat surface of another object that may be carried inside such a parcel with the misting fan 10, such as that of a wallet or a book. At the same time, the actuation surface 64 of the actuator 56 is of sufficient height to accommodate actuation by two or more fingers side-by-side. This allows for a greater force biasing the actuator 56 to the home position than permitted by an actuator that only accommodates actuation by one finger, without compromising user ergonomics. In turn, a greater biasing force reduces the likelihood of accidental spray pump actuation by a smaller object impinging on actuator 56.

The outer dimensions of housing 12 provide the misting fan 10 with a relatively smooth and flat profile, so that the misting fan 10, when worn by the necklace 38 about a user's neck, rests comfortably and unobtrusively against the user's chest or abdomen. In addition to a height as defined above, the housing 12 has a housing width, the housing width measured horizontally from a farthest point in the first horizontal direction on the housing first lateral side 24, to a farthest point in the second horizontal direction on the housing second lateral side 28, and a housing depth, the housing depth measured axially from a farthest rearward point on the housing rear side 36 to a farthest forward point on the housing front side 32. Preferably, a ratio of the housing width to the housing depth is not less than about 2.5 and not greater than about 4.5, and a ratio of the housing height to the housing depth is not less than about 3.0 and not greater than about 6.5. More preferably, a ratio of the housing width to the housing depth is not less than about 3.0 and not greater than about 4.0, and a ratio of the housing height to the housing depth is not less than about 4.0 and not greater than about 5.5. Still more preferably, a ratio of the housing width to the housing depth is about 3.5 and a ratio of the housing height to the housing depth is about 4.75. In terms of absolute measurements, preferably, the housing height is not less than about 3 inches and not greater than about 7 inches, the housing width is not less than about 2 inches and not greater than about 5 inches, and the housing depth is not less than about 0.4 inch and not greater than about 2.0 inches. More preferably, the housing depth is not greater than about 1.5 inches and not less than about 0.5 inch, and still more preferably, the housing depth is not greater than about 1.0 inch and not less than about 0.5 inch.

Components of misting fan 10 may be made of any suitable materials, such as set forth here. Other than electronic components and circuitry, or as otherwise stated, components of and within housing 12 are preferably formed of molded plastic. Water reservoir 46 is preferably formed of a transparent or translucent molded plastic, the seam between forward member 47a and rearward member 47b forming a watertight seal. For example, the seam may be sonically welded. The water reservoir closure member 50 is preferably molded from a suitable elastomer. The necklace 38 may, for example, be a braided cord, wire, cable, chain, or strand of a suitable flexible material.

In view of the foregoing, it should be appreciated that the misting fan described above has several advantages over the prior art.

It should also be understood that when introducing elements in the claims or in the above description of exemplary embodiments, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A misting fan comprising
a housing having a top wall at a top side of the housing, a bottom wall at a bottom side of the housing, a first sidewall at a first lateral side of the housing, a second sidewall at a second lateral side of the housing, a front wall at a front side of the housing, and a rear wall at a rear side of the housing, the top side being spaced from the bottom side, the first lateral side being spaced from the second lateral side, an air inlet at the front side of the housing, and an air outlet at the top side of the housing;
a fan compartment within the housing;
a centrifugal fan disposed within the fan compartment, the centrifugal fan being adapted and configured to rotate about a fan axis, the centrifugal fan being adapted and configured to draw air into the fan compartment from an exterior of the housing through the air inlet and discharge air from the fan compartment to the exterior of the housing through the air outlet;
a water reservoir within the housing, the water reservoir having a fill opening and a water reservoir closure member adapted and configured to removably engage the fill opening to cover and seal the fill opening;
a spray nozzle at the top side of the housing, the spray nozzle being spaced laterally from the air outlet across the top side of the housing;
a spray pump within the housing, the spray pump being adapted and configured to be in fluid communication with water in the water reservoir and with the spray nozzle, the spray pump being adapted and configured, when actuated and in fluid communication with water in the water reservoir, to draw water from the water reservoir to the spray pump, and to impel water from the spray pump to the spray nozzle and through the spray nozzle to the exterior of the housing; and
a spray pump actuator, the spray pump actuator being movably mounted to the housing, the spray pump actuator being adapted and configured to actuate the spray pump when an actuation force is applied to the spray pump actuator to move the spray pump actuator from a home position relative to the housing to an actuation position relative to the housing, the spay pump actuator being disposed on the first sidewall adjacent to the bottom wall.

2. The misting fan of claim 1, further comprising:
a motor, the motor being within the housing and adapted and configured to drive rotation of the centrifugal fan about the fan axis;
an electrical power supply, the power supply being within the housing below the fan compartment and above the water reservoir, the power supply being connected to the motor.

3. The misting fan of claim 1, further comprising a necklace, the necklace being connected to the housing in such a manner that, when the necklace is worn about the neck of a user, the top side of the housing is oriented toward a face of the user.

4. The misting fan of claim 1, wherein the fill opening is at the bottom side of the housing.

5. The misting fan of claim 1, wherein the spray nozzle is adapted and configured so that water being impelled through the spray nozzle to the exterior of the housing causes mist to be discharged from the spray nozzle to the exterior of the housing.

6. The misting fan of claim 1, wherein the spray pump actuator in the home position does not protrude from the housing.

7. The misting fan of claim 1, wherein the spray pump actuator is disposed within a slot on the first lateral sidewall of the housing.

8. The misting fan of claim 7, wherein the first lateral sidewall has a lower first lateral sidewall portion extending from the slot toward the bottom side of the housing, the first lateral sidewall having an upper first lateral sidewall portion extending from the slot toward the top side of the housing, the upper first lateral sidewall portion being longer in dimension than the lower first lateral sidewall portion.

9. The misting fan of claim 8, wherein a distance across the slot from the upper first lateral sidewall to the lower first lateral sidewall portion is at least about one inch.

10. The misting fan of claim 7 wherein the spray pump actuator extends across the slot.

11. The misting fan of claim 1 wherein the spray pump actuator is pivotally connected to the housing.

12. The misting fan of claim 1, further comprising a spray pump connector and a connector tube, the spray pump connector having an inlet section and an outlet section, the connector tube having a first end and a second end, the spray pump connector inlet section facing laterally and being connected to the spray pump, the spray pump connector outlet section facing the top side of the housing and being connected to the first end of the connector tube, the second end of the connector tube being connected to the spray nozzle.

13. The misting fan of claim 12, the spray pump actuator being adapted and configured to move the spray pump connector laterally and actuate the spray pump when the actuation force is applied to the actuator.

14. The misting fan of claim 1, further comprising a biasing member operatively connected between the housing and the spray pump actuator, the biasing member being adapted and configured to bias the actuator toward the home position, the biasing member being adapted and configured to allow the spray pump to be moved to the actuation position when the actuation force is greater than 0.5 lbf.

15. The misting fan of claim 1, wherein the housing has a width corresponding to a maximum distance between the first lateral side and the second lateral side, the housing has a depth corresponding to a maximum distance between the front side and the rear side, and a ratio of the housing width to the housing depth is not less than about 2.5 and not greater than about 4.5.

16. The misting fan of claim 1, wherein the housing has a height corresponding to a maximum distance between the top side and the bottom side and a width corresponding to a maximum distance between the first lateral side and the second lateral side, and a ratio of the housing height to the housing width is not less than about 0.6 and not greater than about 3.5.

17. The misting fan of claim 1, wherein the housing has a height corresponding to a maximum distance between the top side and the bottom side and a depth corresponding to a maximum distance between the front side and the rear side, and a ratio of the housing height to the housing depth is not less than about 3.0 and not greater than about 6.5.

18. The misting fan of claim 1, wherein the housing has a height corresponding to a maximum distance between the top side and the bottom side, and the housing height is not less than about 3 inches and not greater than about 7 inches.

19. The misting fan of claim 1, wherein the housing has a width corresponding to a maximum distance between the first lateral side and the second lateral side, and the housing width is not less than about 2 inches and not greater than about 5 inches.

20. The misting fan of claim 15 wherein the housing depth is not less than about 0.4 inch and not greater than about 2.0 inches.
